(19) United States
(12) Patent Application Publication
(10) Pub. No.: US 2015/0069984 A1
(43) Pub. Date: Mar. 12, 2015

(54) BUCK CONVERTER WITH OVERSHOOT PROTECTION

(71) Applicant: HON HAI PRECISION INDUSTRY CO., LTD., New Taipei (TW)

(72) Inventors: CHE-HSUN CHEN, New Taipei (TW); CHIA-MING YEH, New Taipei (TW)

(73) Assignee: HON HAI PRECISION INDUSTRY CO., LTD., New Taipei (TW)

(21) Appl. No.: 14/096,026

(22) Filed: Dec. 4, 2013

(30) Foreign Application Priority Data
Sep. 10, 2013 (TW) 102132508

(51) Int. Cl. H02M 3/158

(52) U.S. Cl. CPC H02M 3/1588
USPC 323/271

(57) ABSTRACT

A buck converter includes a pulse width modulation unit, a first switch, a second switch, an inductance, and a sensor near the inductance. The pulse width modulation unit controls the first switch and the second switch power to allow or disallow electrical conduction. The sensor senses the state of the inductance in respect of a sound event, a vibration event, and a drop in current level. When the inductance is saturated and gives rise to one or more of the foregoing events, the sensor sends a signal to the pulse width modulation unit, which controls the first switch to cut off power and the second switch to allow conduction, allowing the inductance to release all its electrical energy.

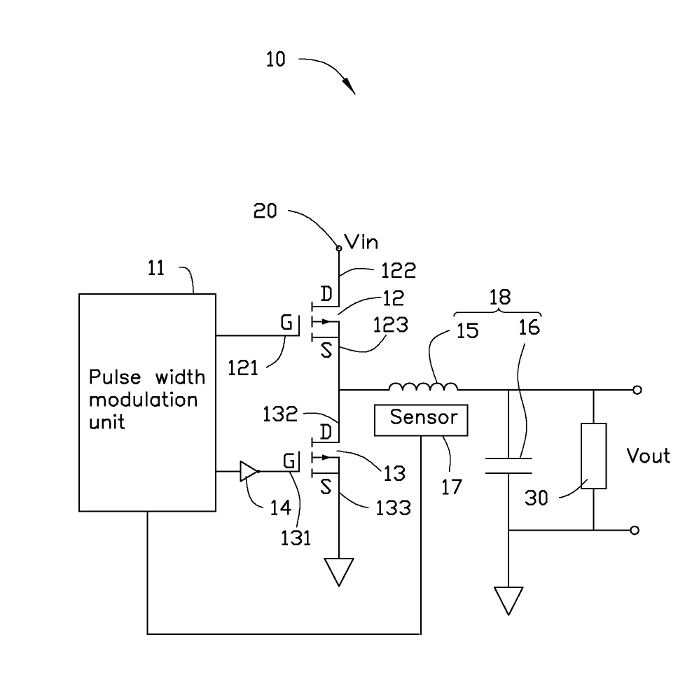

### BACKGROUND

1. Technical Field

The present disclosure relates to power supplies and, particularly, to a buck converter with overshoot protection.

2. Description of Related Art

Buck converters are used in motherboards. The buck converter mainly includes a main switch, a secondary switch, and an inductance. A high frequency switching mode is applied between the main switch and the secondary switch to make the inductance store or discharge energy to supply a load.

The inductance can be saturated and then the inductance equates to a short circuit. A large current can pass through all of the inductance, the main switch, and the secondary switch. Thus, the larger current can damage the inductance and destroy the buck converter.

Therefore, it is desirable to provide a buck converter with overshoot protection, which can overcome the limitation described.

### BRIEF DESCRIPTION OF THE DRAWINGS

The components of the drawing are not necessarily drawn to scale, the emphasis instead being placed upon clearly illustrating the principles of the embodiments of the present disclosure.

The FIGURE is a schematic view of a buck converter with overshoot protection, according to an exemplary embodiment of the present disclosure.

### DETAILED DESCRIPTION

The figure shows an exemplary embodiment of a buck converter 10. The buck converter 10 is configured with a function of overshoot protection. The buck converter 10 is configured for converting an input voltage 20 into a suitable voltage to apply to a load 30.

The buck converter 10 includes a pulse width modulation unit 11, a first switch 12, a second switch 13, an inverter 14, an inductance 15, a capacitor 16, and a sensor 17. The inductance 15 and the capacitor 16 operate as a low-pass filter 18. The sensor 17 is located near the inductance 15 for sensing the status of the inductance 15.

The pulse width modulation unit 11 is connected to the first switch 12. The second switch 13 is connected to the pulse width modulation unit 11 through the inverter 14. The pulse width modulation unit 11 controls the first switch 12 and the second switch 13 to allow conduction and to cut off conduction. The input voltage 20 is applied to the load 30 through the low-pass filter 18.

The first switch 12 can be a metal oxide semiconductor field effect transistor (MOSFET) or a bipolar junction transistor (BJT). The second switch 13 can also be a MOSFET or a BJT. In this embodiment, the first switch 12 is a MOSFET and the second switch 13 is a MOSFET.

The first switch 12 includes a first gate 121, a first drain 122, and a first source 123. The second switch 13 also includes a second gate 131, a second drain 132, and a second source 133.

The first gate 121 of the first switch 12 is directly connected to the pulse width modulation unit 11. The first drain 122 is connected to the input voltage 20. The first source 123 is connected to the inductance 15. The second gate 131 of the second switch 13 is connected to the pulse width modulation unit 11 through the inverter 14. The second drain 132 is connected to the inductance 15 and the first source 123. The second source 133 is grounded.

In other embodiment, the first gate 121 of the first switch 12 is connected with the pulse width modulation unit 11 through the inverter 14, but the second gate 131 of the second switch 13 is directly connected to the pulse width modulation unit 11.

A high level signal is applied to the first drain 122 and the first source 123, so the first switch 12 conducts and the second switch 13 cuts off conduction. The first switch 12 and the inductance 15 form a loop, the inductance 15 stores energy applied from the input voltage 20. Current through the inductance 15 decreases, and the input voltage 20 is applied to the load 30.

A low level signal is applied to the first gate 121 of the first switch 12 and the first source 123, so the first switch 12 cuts off conduction. According to Lenz's law, a counter or back electromotive force is generated in the inductance 15 as the first switch 12 cuts off conduction, thus the second switch 13 is powered on. Under this condition, the inductance 15 discharges energy to the load 30.

The inductance 15 is a magnetic element. If the inductance 15 stores excessive energy, the inductance 15 can be damaged. The worst condition is that the buck converter 10 is also damaged.

When the inductance 15 is saturated with current, one or more of a sound, a vibration, and a decrease in current can happen. The sensor 17 near the inductance 15 can sense any one or more of these happenings. When the sensor 17 senses such a happening, the sensor 17 sends a signal to the pulse width modulation unit 11. The plus width modulation unit 11 controls the first switch 12 to cut off conduction and the second switch 13 to power on. The inductance 15 thus discharges all the contained energy and protection for the inductance 15 is thus achieved.

The sensor 17 is selected from the group consisting of an acoustic sensor and a vibration sensor.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely exemplary embodiments of the disclosure.

What is claimed is:

1. A buck converter, comprising:
a pulse width modulation unit;
a first switch;
a second switch; and
an inductance, the pulse width modulation unit being configured for controlling the first switch and the second switch to conduct on and cut off conduction, wherein a sensor is located near the inductance to sense status of the inductance, when the inductance is saturated, the sensor sends a signal to the pulse width modulation unit to cut-off the first switch and conduct the second switch, and the inductance discharges.

2. The buck converter of claim 1, wherein the first switch is a MOSFET and the second switch is a MOSFET.

3. The buck converter of claim 2, wherein the first switch comprises a first gate, the second switch comprises a second gate, the first gate is connected to the pulse width modulation unit, the second gate is connected with the pulse width modulation unit through an inverter.

4. The buck converter of claim 2, wherein the first switch comprises a first gate, the second switch comprises a second gate, the second gate is connected with the pulse width modulation unit, and the first gate is connected with the pulse width modulation unit through an inverter.

5. The buck converter of claim 1, wherein the first switch is a BJT and the second switch is a BJT.

6. The buck converter of claim 1, wherein the sensor is selected from the group consisting of an acoustic sensor and a vibrating sensor.

7. The buck converter of claim 1, comprising a capacitor, the capacitor and the inductance constituting a low-pass filter.
